(19) United States
(12) Patent Application Publication
(10) Pub. No.: US 2026/0085208 A1
(43) Pub. Date: Mar. 26, 2026

(54) POLYIMIDE AND METHOD OF MANUFACTURE

(71) Applicant: ESSEX SOLUTIONS USA LLC, Atlanta, GA (US)

(72) Inventors: Frederick M. McFarland, Fort Wayne, IN (US); Tamanna F. McFarland, Fort Wayne, IN (US); Allan R. Knerr, Fort Wayne, IN (US); Matthew E. Leach, Fort Wayne, IN (US)

(21) Appl. No.: 18/891,520

(22) Filed: Sep. 20, 2024

(51) Int. Cl. C09D 179/08; C08G 73/10; H01B 3/30; H01F 5/06

(52) U.S. Cl. CPC C09D 179/08; C08G 73/1017; C08G 73/1071; H01B 3/306; C08G 2150/00; H01F 5/06

(57) ABSTRACT

A polyimide formed from the reaction of a dianhydride monomer and diamine involving and endcapped acid terminated dianhydride intermediate. The polyimide is suitable for use as a coating on wire and in particular magnetic wire so as to form insulation to improve longevity of wire and wire-based components.

### CROSS-REFERENCE TO RELATED APPLICATIONS

The present application is related to U.S. patent application Ser. No. ______ (Attorney Docket SPSX-1099) filed on Sep. 20, 2024 and entitled “A Polyimide and Method of Manufacture”, the contents of which are incorporated by reference herein in its entirety.

### FIELD OF THE DISCLOSURE

The present subject matter relates to a polyimide formed from the reaction of a dianhydride monomer and a diamine involving an endcapped acid terminated dianhydride intermediate, the polyimide being suitable for use as a coating on wire and in particular magnet wire so as to form insulation to improve the longevity of wire and wire-based components.

### BACKGROUND

Magnet wire, also referred to as winding wire or magnetic winding wire, is utilized in a wide variety of electric machines and devices, such as inverter drive motors, motor starter generators, transformers, etc. Magnet wire typically includes polymeric enamel insulation formed around a central conductor. The enamel insulation is formed by applying a varnish onto the magnet wire and curing the varnish in an oven to remove solvents, thereby forming a thin enamel layer. This process is repeated until a desired enamel build or thickness has been attained. Polymeric materials utilized to form enamel layers are intended for use under certain maximum operating temperatures. Additionally, electrical devices may be subject to relatively high voltage conditions that may break down or degrade the wire insulation. For example, an inverter may generate variable frequencies that are input into certain types of motors, and the variable frequencies may exhibit steep wave shapes that cause premature motor winding failures.

Attempts have been made to reduce premature failures as a result of degradation of the wire insulation. These attempts have included minimizing damage to the wire and insulation during handling and manufacture of electric machines and devices and using shorter lead lengths where appropriate. Further, a reactor coil or a filter between and inverter drive and a motor can extend the life of the windings by reducing the voltage spikes and high frequencies generated by the inverter drive/motor combination.

U.S. Pat. No. 10,796,820 B2 describes magnet wire having a layer of a polymeric corrosion resistant enamel insulation. The polymeric enamel may include a filler dispersed in a polyimide and an additive formed by reacting an amine moiety with a formaldehyde material. The filler may include silica or titanium dioxide.

US 2018/286,532 A1 discloses a wire containing a conductor, an adhesion layer provided in direct contact with the conductor, and an insulating layer formed from a polyimide resin, provided on the adhesion layer.

U.S. Pat. No. 6,469,126 B1 describes semicrystalline, melt-processible copolyimides that exhibit recoverable semicrystallinity relative to their melts. Associated processes, which entail either solution polymerization or melt polymerization, for producing and fabricating copolyimides into articles having a predetermined shape is also disclosed.

U.S. Pat. No. 6,828,390 B2 discloses high modulus, dimensionally stable films formed via an interpenetrating polyimide network of two polyimide structures, interlocked and bonded on a molecular level. The polyimide components are made from a dianhydride and a diamine. An endcapping agent is used within the synthetic pathway and includes a carboxylic anhydride or a silanating agent. A second polyimide is polymerized in the presence of the first polymer to form a single-phase system.

US 2023/116,635 A1 discloses a polyimide obtained by a reaction of a diamine and a tetracarboxylic dianhydride, in which the diamine may be an aromatic diamine or an alicyclic diamine. The tetracarboxylic dianhydride may be an aromatic tetracarboxylic dianhydride or an alicyclic tetracarboxylic dianhydride.

As will be appreciated, wire and magnetic wire components are expensive and add to the overall cost of a system. Increasing the amount of insulation can improve the life of the windings in an electrical device. However, this option is both expensive and decreases the amount of space for the conductor in the device, thereby producing a less efficient motor. Alternatively, increasing the amount or thickness of insulation can either lead to larger, heavier electric devices or the use of smaller conductors due to space limitations within electric devices, both scenarios being undesirable for many applications, such as automotive applications. Additionally, inter layer delamination may occur once a certain number of enamel layers has been reached.

Temperature thermal index (TI) or thermal index (TI) of dielectric materials is a valuable measure of thermal capability upon which the material's thermal endurance capability can be evaluated and a thermal class assigned. It is therefore an important quality for end-users. Numerous high thermal endurance polymers, including polyimides, used as dielectric coatings typically have a thermal index of equal to or less than 240° C. Fillers may be added to these temperature-resistance polymers with such fillers imparting additional thermal, chemical and/or electrical resistance. However, mechanical properties can be impaired due to localized stress concentrations and heightened fracture propagation between the polymer matrix and rigid particles. Filled insulation layers may also be relatively abrasive and, therefore, an unfilled topcoat layer is typically formed over filled insulation to facilitate easier handling of wire when incorporated into electric devices.

Accordingly, what is required is a coating for wire suitable for use within power and electronic devices such as stators and rotors capable of withstanding thermal and electrical stresses for longer periods of time.

### SUMMARY

It is an objective of the present concept to provide a polymer coating for wire and preferably magnetic wire having thermal and electrical insulating characteristics configured to withstand thermal and electrical stress.

It is a further specific objective to provide a polymer suitable to form a coating on a wire and preferably magnetic wire exhibiting a high thermal index or relative thermal index. It is a further specific objective to provide a polymer coating formed as a polyamide to provide service longevity of wire within power devices and electrical devices including use within a stator and/or a rotor.

The objectives are achieved via a polyimide and optionally a copolyimide, according to the present concept, in which an endcapped acid terminated dianhydride intermediate is formed within the reaction pathway. Such an endcapped acid terminated dianhydride intermediate is advantageous to increase the molecular weight of the final polyimide whilst also providing a reaction pathway enabling composition variation and a polyimide provided with enhanced chemical, mechanical, electrical and thermal insulating characteristics. Furthermore, the present polyimide is configured for high thermal and electrical stress resistance as an unfilled or filled coating on wire and preferably magnetic wire.

According to a first aspect of the present concept there is provided A polyimide having a formula 1:

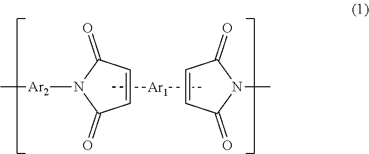

wherein Ar₁ is alkyl, phenyl or mixed alkyl-phenyl; or
wherein Ar₁ is a substituted or unsubstituted condensed aromatic ring or rings, a naphthalene, pyrene, and/or anthracene ring, or a substituted or unsubstituted heterocycle, a furan ring, a pyridine ring or an imidazole ring; and
wherein Ar₂ is a divalent phenyl ether, alky ether or alky-phenyl ether.

Optionally, the polyimide may be formed as a thermosetting or thermoset material configured to be irreversibly cured (i.e., heat cured, etc.) as a coating on wire and preferably magnetic wire. Advantageously, the present polyimide is suitable to provide a high solids content coating with regard to the solids content of a liquid suspension containing the polyimide precursor i.e. the polyamic acid oligomer.

Optionally, Ar₁ is any one or a combination of: phenyl; biphenyl; benzophenone; biphenylether; diphenylsulfone. Optionally, Ar₁ is any one or a combination of: an alkane; a cycloalkane; cyclohexane. Optionally, Ar₂ is divalent diphenyl ether. Optionally, Ar₁ is biphenyl and Ar₂ is divalent diphenyl ether.

According to a further aspect of the present concept there is provided a polyimide according to formula 1 herein formed from, derived from or being the reaction product of a polyimide comprising a reaction product of: (A) a first reaction of a dianhydride monomer and an endcapping component to yield an endcapped acid terminated dianhydride intermediate; (B) a second reaction of the endcapped acid terminated dianhydride intermediate, a diamine and a dianhydride monomer to yield a polyamic acid oligomer in which the endcapping component is a leaving group; and (C) a third reaction comprising heating the polyamic acid oligomer to yield the polyimide.

Reference within the specification to ‘an endcapped acid terminated dianhydride intermediate’ includes a compound having the structural formula 1.

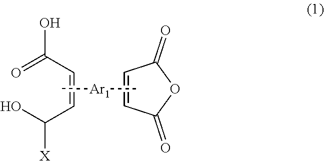

Reference within the specification to ‘a polyamic acid oligomer’ includes a compound having the structural formula 2.

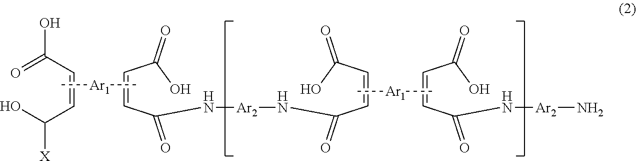

Reference within the specification to ‘a polyimide’ includes a compound having the structural formula 3 . . . .

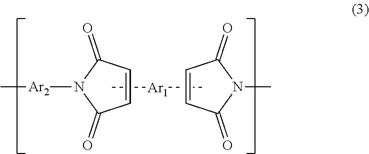

wherein Ar₁ is alkyl, phenyl or mixed alkyl-phenyl; or wherein Ar₁ is a substituted or unsubstituted condensed aromatic ring or rings, a naphthalene, pyrene, and/or anthracene ring, or a substituted or unsubstituted heterocycle, a furan ring, a pyridine ring or an imidazole ring; and wherein Ar₂ is a divalent phenyl ether, alky ether or alky-phenyl ether; and X is an endcapping group such as an amine, a secondary amine, a phthalic anhydride in formulae 1, 2 and/or 3. Within this specification, reference to a wherein Ar₁ and unless stated Ar₂ encompasses the divalent equivalent such as a divalent alkyl, phenyl or mixed alkyl-phenyl as will be appreciated.

Reference within the specification to ‘an endcapping component’ encompasses a monofunctional component, agent or reactive species encompassing specific compounds such as amines, secondary amines, a phthalic anhydride. The endcapping component is configured to end-block the dianhydride monomer to form the acid terminated dianhydride intermediate blocked with the endcapping component. The endcapping component within the reaction pathway provides a terminal leaving group as part of the polyamic acid oligomer. The endcapping component is accordingly generated during the third reaction (heating and curing the polyamic acid oligomer as a final stage to generate the copolyimide).

The present polyimide is preferably formed as a copolymer. Such a copolymer repeating units are created by the reaction of the which the dianhydride monomer (first monomer) with the diamine (second monomer). Within this specification, constituents of the two repeat units are expressed as Ar₁ and Ar₂ corresponding to the dianhydride monomer and the diamine, respectively. Preferably, Ar₁ and Ar₂ are different. Alternatively in certain embodiments Ar₁ and Ar₂ may be the same.

Preferably, the endcapping component is a primary amine or a secondary amine. Optionally, the secondary amine comprises any one or a combination of: N-alkylaniline; N-phenylaniline; N-alkyphenylaniline; N-methylaniline (NMA).

Optionally, the endcapping component may be phthalic anhydride.

Optionally, the dianhydride monomer of the first reaction is a singular type of dianhydride monomer and/or the endcapped acid terminated dianhydride intermediate of the first reaction is a singular type of endcapped acid terminated dianhydride intermediate.

Optionally, the dianhydride monomer of the first reaction is the same dianhydride monomer as the second reaction; the dianhydride monomer of the first reaction is different to the dianhydride monomer as the second reaction; or the dianhydride monomer of the second reaction is combination of at least two different types of dianhydride monomer and optionally wherein the dianhydride monomer of the first reaction is the same or different to said at least two different types of dianhydride monomer of the second reaction.

Optionally, the dianhydride monomer of the first reaction and/or the second reaction comprises any one or a combination of: a cyclic anhydride; a carbocyclic carboxylic anhydrides; a phthalic anhydride or substituted phthalic anhydride; 3,3′,4,4′-biphenyltetracarboxylic dianhydride (BPDA); pyromellitic acid dianhydride (PMDA); 3,3′,4,4′-benzophenone tetracarboxylic acid dianhydride (BTDA); 3,3′,4,4′-biphenylether tetracarboxylic acid dianhydride (OPDA); diphenylsulfone tetracarboxylic acid dianhydride (DSDA); bicyclo(2,2,2)-octo-7-ene-2,3,5,6-tetracarboxylic acid dianhydride (BCD); 1,2,4,5-cyclohexane tetracarboxylic acid dianhydride (H-PMDA); 2,2-bis(3,4-dicarboxypheny) hexafluoro propane dianhydride (6FDA); 5-(2,5-dioxotetrahydrofuryl)-3-methyl-3-cyclohexene-1,2-dicarboxylic acid anhydride (CP), 4,4′-[propane-2,2-diylbis(1,4-phenyleneoxy)]diphthalic acid dianhydride (BISDA); 4,4′-oxydiphthalic acid anhydride (ODPA).

Optionally, the diamine comprises any one or a combination of: an aromatic diamine; an aliphatic diamine; oxydianiline (ODA); 3,4′-oxydianiline (3,4′-ODA); 4,4′-oxydianiline (4,4′-ODA); 1,4-bis(4-aminophenoxy)benzene (TPE-Q); 2,2-bis [4-(4-aminophenoxy)phenyl]propane (BAPP); p-phenylene diamine (PPDA).

Optionally the dianhydride monomer of the first reaction and/or the second reaction comprises 3,3′,4,4′-biphenyltetracarboxylic dianhydride (BPDA); the diamine comprises oxydianiline (ODA); and the endcapping component is any one or a combination of: N-alkylaniline; N-phenylaniline; N-alkyphenylaniline; N-methylaniline (NMA).

Optionally, the dianhydride monomer of the first reaction comprises 3,3′,4,4′-biphenyltetracarboxylic dianhydride (BPDA); the dianhydride monomer of the second reaction comprises 3,3′,4,4′-biphenyltetracarboxylic dianhydride (BPDA); the diamine comprises oxydianiline (ODA); and the endcapping component is any one or a combination of: N-alkylaniline; N-phenylaniline; N-alkyphenylaniline; N-methylaniline (NMA).

Optionally, the dianhydride monomer of the first reaction comprises pyromellitic acid dianhydride (PMDA); the dianhydride monomer of the second reaction comprises 3,3′,4,4′-biphenyltetracarboxylic dianhydride (BPDA); the diamine comprises oxydianiline (ODA); and the endcapping component is any one or a combination of: N-alkylaniline; N-phenylaniline; N-alkyphenylaniline; N-methylaniline (NMA).

Optionally, an intrinsic viscosity of >0.2, >0.22, >0.24, or >0.26, m³/kg as measured using measured International Standard ISO 1628-1:2021(en).

Optionally, a stoichiometry of the first reaction comprises the dianhydride monomer and the endcapping component at 1:1 respectively. Optionally, the endcapped acid terminated dianhydride intermediate comprises a single endcapping component per dianhydride monomer. Optionally, a stoichiometry of the second reaction comprises the endcapped acid terminated dianhydride intermediate and excess diamine at 1:2 respectively.

Optionally, the polyimide is a thermoset material. However, according to some embodiments, the polyimide may comprise thermoplastic characteristics. In particular, according to certain embodiments, polyimide according to the present concept may contain a greater degree of flexible monomers. Such monomers may include ODPA, 6FDA, BAPP etc.

According to a further aspect of the present concept there is provided a liquid suspension comprising: a liquid solvent; and the polyamic acid oligomer according to any one of claims and embodiments as described herein provided as a solid and suspended within the solvent; and wherein a solids content of the liquid suspension is in the range 10 to 50, 15 to 45, 15 to 40, 20 to 40 wt % of the total mass of the liquid solvent in combination with the polyamic acid oligomer.

According to a further aspect of the present concept there is provided a composite material comprising: the polyimide according to any one of claims and embodiments herein; and a filler.

Optionally, the filler may comprise any one or a combination of: titanium dioxide (TiO₂); silicon dioxide (SiO₂); chromium IV oxide (Cr₂O₃).

According to a further aspect of the present concept there is provided a wire comprising a coating comprising the polyimide as claimed in any one of claims and embodiments herein or the composite material as claimed in any one of claims and embodiments herein.

Optionally, the coating may comprise multiple layers of the polyimide bonded to one another as a unitary coating.

Optionally, the coating may comprise a thermal index greater than 260° C., or in the range 255 to 275° C., as determined by International Standard ASTM D2307. Optionally, the coating may comprise the composite material as claimed herein and a thermal index greater than 270° C., greater than 280° C. or in the range 265° C. to 285° C. as determined by International Standard ASTM D2307.

According to a further aspect of the present concept there is provided an electrical device or electronic equipment comprising the wire according in any one of claims and embodiments herein.

Optionally, a mole ratio of the dianhydride monomer and the endcapping component is 1:1. Optionally, a mole ratio of the endcapped acid terminated dianhydride intermediate and the diamine is 1:2; and/or a mole ratio of the polyamic acid oligomer, the dianhydride monomer and the diamine is 1:2:2.

### BRIEF DESCRIPTION OF THE DRAWINGS

A specific implementation of the present invention will now be described, by way of example only, and with reference to the accompanying drawings in which:

FIGS. 1A-1D are cross sectional views of example magnet wires incorporating a polyimide coating according to specific implementations of the present concept.

### DETAILED DESCRIPTION

Copolyimides of the present concept are the reaction products of dianhydride monomers, endcapping components and diamines. The reaction pathway involves forming an acid terminated dianhydride intermediate at an initial stage and a polyamic acid oligomer at a second intermediate stage. The polyamic acid oligomer may be suspended within a solvent system to be then heated/cured as a coating on wire and preferably magnetic wire. According to various embodiments, the final polyimide coating may be filled or unfilled as desired.

A generic reaction scheme of the present concept may be represented by the following schematic. A secondary amine (N-methyl aniline) is used as the endcapping compound. It is noted secondary amines have been found to be advantageous to facilitate the reaction by providing an effective leaving group at the final curing stage.

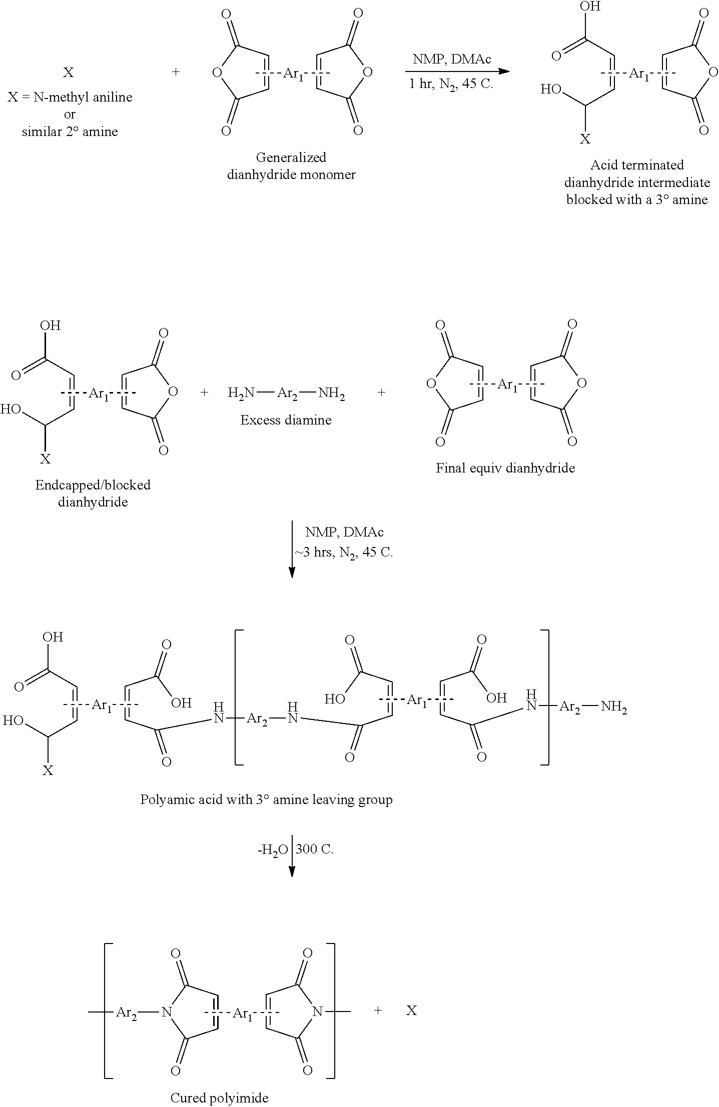

wherein Ar₁ is alkyl, phenyl or mixed alkyl-phenyl; or wherein Ar₁ is a substituted or unsubstituted condensed aromatic ring or rings, a naphthalene, pyrene, and/or anthracene ring, or a substituted or unsubstituted heterocycle, a furan ring, a pyridine ring or an imidazole ring; and wherein Ar₂ is a divalent phenyl ether, alky ether or alky-phenyl ether.

The present copolyimide may be described with reference to the following illustrative examples. It would be appreciated the present concept extends beyond the listed examples and may comprise a wide range of different types of dianhydride monomer, diamine and endcapping component optionally with or without fillers.

### Examples

### Synthetic Pathway

An example synthetic pathway according to example A below comprises

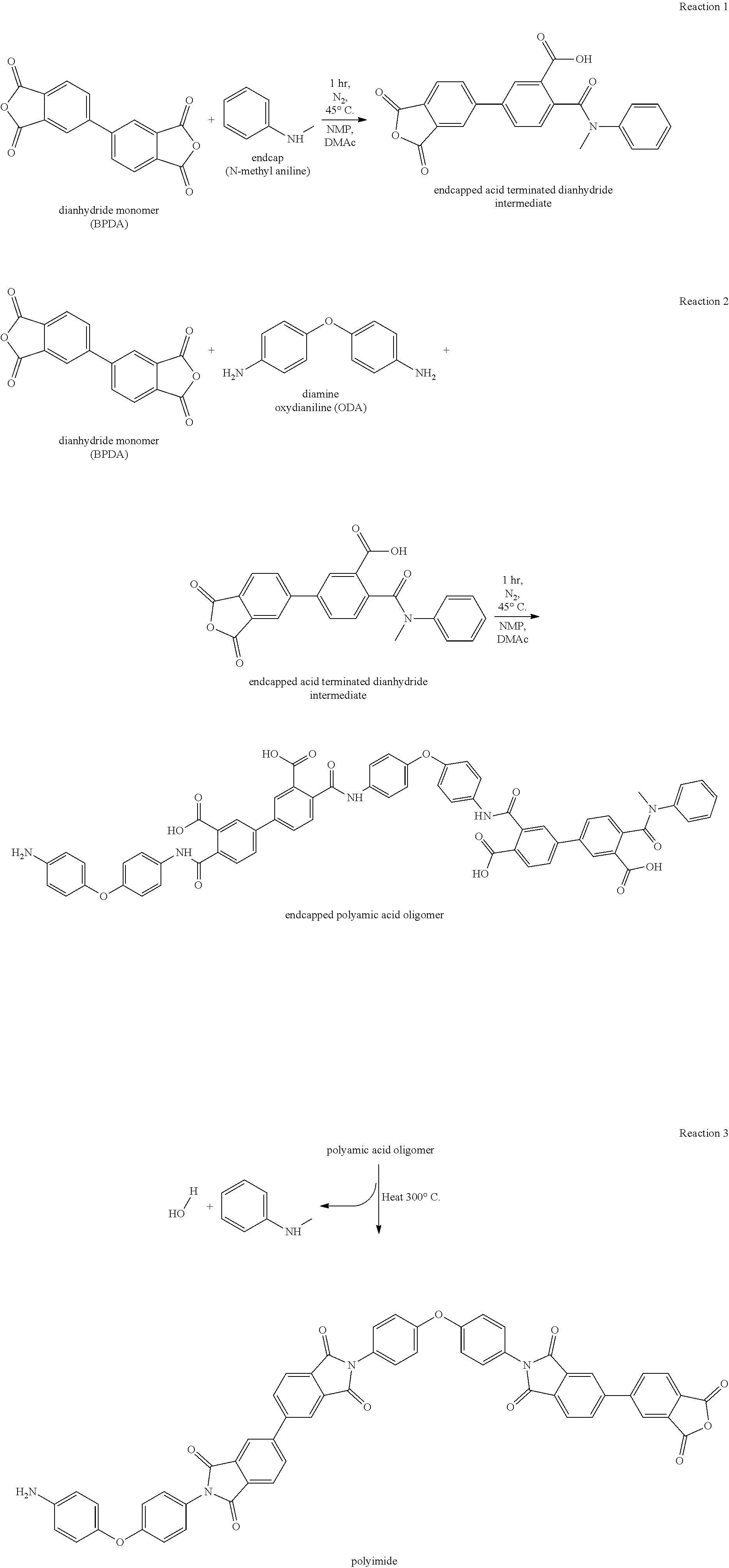

### Example A. Selectively Endcapped NMA-BPDA/ODA/BPDA Polyimide

Synthesis of a selectively endcapped ODA/BPDA polyamic acid was performed using a 1000 mL round bottom flask equipped with a high torque mechanical stirrer, thermocouple, and nitrogen purge. In the clean dry flask, 200.00 g of N-methyl-2-pyrrolidone (NMP, Lyondell Chemical Company, USA, 99.97%) and 200.00 g of dimethylacetamide (DMAc, Univar Solutions, USA, 99.98%) were added under the nitrogen flow, and heated to 45° C. while stirred at 250-300 rpm. The water content of the solvent mixture was determined to be 0.032% using a Karl Fischer titrator.

First, 4.94 g of N-methylaniline (NMA, TCI America, USA, 99.40%) was added dropwise followed by 6.78 g of 3,3′,4,4′-Biphenyltetracarboxylic dianhydride (BPDA, Shanghai Gu New Chemical Materials Co. Ltd., China, 99.50%). A homogeneous solution containing stoichiometric equivalent amounts of NMA end-capped BPDA (EC-BPDA) resulted after an hour of mixing at 45° C.

4,4′-Oxydianiline (41.52 g, ODA, Shandong Guansen Polymers Materials Science and Technology Inc., China, 99.80%) was added to the solution of EC-BPDA. ODA immediately dissolved, resulting in a bright yellow transparent solution. Finally, BPDA (54.08 g) was gradually added to the mixture of EC-BPDA and ODA, stirred at 45-50° C. for 3 hours, and then cooled to yield a low viscosity yellow-orange polyamic acid solution.

Film samples were prepared by casting the resin onto a 11×7 in high temperature ceramic glass plate using a 100-micron gap coating blade. The wet film was cured at 100° C. in a BLUE M industrial oven for one hour, before ramping to 200° C. and then 300° C., each for one hour. The resulting cured film exhibits an inherent viscosity (IV) of >2.25 dL/g measured at 25° C. compared the non-endcapped polyimide, Control A, which has a film IV of <1.72, where the inherent viscosity (IV) is measured using measured International Standard ISO 1628-1:2021(en).

### Example B. Randomly Endcapped ODA/NMA/BPDA Polyimide

A similar apparatus in sample A is utilized to produce a randomly endcapped ODA/BPDA polyamic acid. NMP and DMAc (120.00 g each) were added to the reaction vessel and heated to 45° C. under a nitrogen blanket. Once stable, 24.91 g of ODA was added to the solvent, dissolving immediately into a transparent light pink solution. Afterwards, 2.96 g of NMA was added dropwise. To this solution, 36.42 g of BPDA was added to the mixture in small amounts to prevent runaway exotherms and stirred for 3 hrs at 45-50° C. After BPDA has reacted completely, a slightly more viscous polyamic acid solution results suitable for wet film casting.

Film samples were prepared similarly as Example A. The resulting cured film has an IV of >2.77 dL/g.

### Example C. Selectively Endcapped NMA-BPDA/ODA/BPDA Polyimide (Higher Solids)

A 500 mL round bottom flask, equipped with a high torque mechanical stirrer, thermocouple, and nitrogen purge was utilized in the production of a selectively endcapped ODA/BPDA polyamic acid. NMP and DMAc (97.50 g each) were introduced into the flask and heated to 45° C. Once the temperature was stable, 10.99 g of NMA was introduced dropwise, followed by 15.08 g BPDA. After one hour of mixing, a homogenous solution of EC-BPDA resulted. To this solution, 41.06 g of ODA was added. Then, 45.03 g of BPDA was added slowly to the mixture, keeping temperatures at approximately 45-50° C. for 3 hours. When the BPDA has completely reacted, a low viscosity polyamic acid solution results suitable for wet film casting.

The resulting cured film has an IV of >2.24 dL/g measured using measured International Standard ISO 1628-1:2021(en).

### Example D. Randomly Endcapped ODA/NMA/BPDA Polyimide (Higher Solids)

A similar production apparatus was used from Sample C to formulate a high solid randomly blocked ODA/BPDA polyamic acid. NMP and DMAc (97.50 g each) was first heated to 45° C., while stirring, under a nitrogen blanket. Once temperature-stable, 41.06 g of ODA was added to the solvent, dissolving immediately. Afterwards, 10.99 g of NMA was added dropwise. To this solution, 60.04 g of BPDA was added to the mixture of NMA and ODA in small amounts to prevent runaway exotherms. After stirring for 3 hrs at 45-50° C., BPDA reacted completely, resulting in a viscous polyamic acid solution suitable for casting in an analogous manner as Sample A.

Upon cooling, the resin was cast onto a glass plate as mentioned earlier, and the resulting cured film exhibits an inherent viscosity of ≥2.27 dL/g measured using measured International Standard ISO 1628-1:2021(en).

### Example E. Selectively Endcapped NMA-PMDAJODA/BPDA Polyimide

A 500 mL round bottom flask, equipped with a high torque mechanical stirrer, thermocouple, and nitrogen purge was to produce a selectively endcapped pyromellic dianhydride (PMDA, Shandong Helishi Petrochemical Technology Development Co., Ltd., 99.80%) attached to an ODA/BPDA polyamic acid. NMP (162.50 g) and DMAc (162.50 g) were introduced into the flask and heated to 45° C. The water content was 0.041% using a Karl Fischer titrator.

Once stable, 8.80 g of NMA was introduced dropwise, followed by 8.95 g PMDA. After one hour of mixing, 73.96 g of ODA was added to the solvent, dissolving immediately. 96.12 g of BPDA was added slowly to the mixture of EC-PMDA and ODA to prevent runaway exotherm, keeping temperatures approximately 45-50° C. for 3 hours. Afterwards, a low viscosity polyamic acid solution results suitable for film casting.

The resulting cured film shows an inherent viscosity of (>2.16 dL/g) measured using measured International Standard ISO 1628-1:2021(en).

### Control A. Non-Endcapped ODA/BPDA Polyimide (Low Equivalence):

Synthesis of a non-endcapped ODA/BPDA polyamic acid was carried out in a 1000 mL round bottom flask, equipped with a mechanical stirrer, thermocouple, and nitrogen purge. A 1:1 ratio of 200.00 g of NMP and 200.00 g DMAc solvent was added to the flask and heated to 45° C. The water content of the solvent mixture was 0.037% using a Karl Fischer titrator.

43.68 g of ODA was added first, which dissolves immediately, resulting in a faint pink transparent solution. 62.32 g of BPDA was added to the solution slowly to prevent a runaway exothermic reaction. After stirring for 3 hrs at 45-50° C., BPDA reacted completely, resulting in a viscous yellow-orange polyamic acid solution with a molar equivalent of 0.970 BPDA:ODA.

The resulting cured film shows an inherent viscosity of (>1.72 dL/g) is measured using measured International Standard ISO 1628-1:2021(en).

### Control B. Non-Endcapped ODA/BPDA Polyimide (High Equivalence):

Synthesis of a non-endcapped ODA/BPDA polyamic acid was carried out in a 1000 mL round bottom flask, equipped with a mechanical stirrer, thermocouple, and nitrogen purge. A 1:1 ratio of 200.00 g of NMP and 200.00 g DMAc solvent was added to the flask and heated to 45° C. The solvents' water content was found to be 0.037% using a Karl Fischer titrator.

43.68 g of ODA was added first, which dissolves immediately, resulting in a faint pink transparent solution. 63.87 g of BPDA was added to the solution slowly to prevent a runaway exothermic reaction. The reaction continued at 45-50° C. for 3 hours and then cooled. After all of the BPDA has reacted, the polymer resin will eventually become a viscous yellow-orange polyamic acid solution with a molar equivalent of 0.970 BPDA:ODA.

The resulting casted and cured film has an inherent viscosity of (>3.06 dL/g) measured using measured International Standard ISO 1628-1:2021(en).

### Control C. Non-Endcapped PMDA/ODA/BPDA Polyimide:

Synthesis of a non-endcapped PMDA/ODA/BPDA polyamic acid was carried out in a 1000 mL round bottom flask, equipped with a mechanical stirrer, thermocouple, and nitrogen purge. A 1:1 ratio of 162.50 g of NMP and 162.50 g DMAc solvent was added to the flask and heated to 45° C.

First, 73.96 g of ODA was added that dissolves immediately, resulting in a faint pink transparent solution. Then 8.95 g of PMDA was added to the solution slowly and allowed to stabilize, forming a homogenous solution. Afterwards, 93.70 g of BPDA was added to prevent a runaway exothermic reaction. The reaction continued at 45-50° C. for 3 hours and cooled. After all of the BPDA had reacted, the polymer resin eventually resulted in a yellow-orange polyamic acid solution with a molar equivalent of 0.971 dianhydride:diamine. The enamel was then diluted to 20% solids using a 312.00 g of 50:50 solvent blend of DMAc and NMP.

Upon cooling, the resin was cast onto a glass plate as mentioned earlier. The resulting cured film exhibits an inherent viscosity of (>2.04 dL/g) measured using measured International Standard ISO 1628-1:2021(en).

TABLE 1
Physical and mechanical characteristics

| | Example | Example | Example | Example | Control | Control |
|---|---|---|---|---|---|---|
| BPDA-capped | A | B | C | D | A | B |
| Solids (wt. %) | 20 | 20 | 32 | 32 | 20 | 21 |
| Viscosity at 30° C. (cps) | 250 | 5500 | 1700 | 39000 | 2500 | 25500 |
| *Film IV (dL/g 25° C.) | 2.25 | 2.77 | 2.34 | 2.27 | 1.72 | 3.06 |
| mole BPDA/mole ODA | 0.886 | 0.884 | 0.746 | 0.745 | 0.971 | 0.995 |
| EC-BPDA mole/mole | 0.111 | 0.111 | 0.250 | 0.250 | 0 | 0 |
| ODA | | | | | | |
| (EC-BPDA mole + | | | | | | |
| BPDA mole)/mole | 0.997 | 0.995 | 0.996 | 0.995 | 0.971 | 0.995 |
| ODA | | | | | | |

TABLE 2
Physical and mechanical characteristics

| | Example | Control |
|---|---|---|
| PMDA-capped | E | C |
| Solids (wt. %) | 20 | 20 |
| Solution Viscosity 30° C. (cps) | 250 | 3700 |
| *Film IV (dL/g 25° C.) | 2.16 | 2.04 |
| mole BPDA/mole ODA | 0.885 | 0.862 |
| mole PMDA/mole ODA | 0.111 | 0.111 |
| EC-PMDA mole/mole ODA | 0.111 | 0.000 |
| (EC-PMDA mole + PMDA mole + | 0.996 | 0.973 |
| BPDA mole)/mole ODA | | |

### Further Examples

Copolyimide may be synthesized according to the following further non-exhaustive and illustrative examples detailed in table 3.

TABLE 3
Further example starting materials to synthesize
copolyimides according to the present concept

| | Endcap | Capped | | |
|---|---|---|---|---|
| Example | monomer | Dianhydride | Dianhydride | Diamine |
| F | NBzA | BPDA | BPDA | ODA |
| G | NBzA | PMDA | BPDA | ODA |
| H | NEA | PMDA | ODPA | ODA |
| I | NEA | OPDA | BTDA | TPE-Q |
| J | NEA | BTDA | PMDA | ODA |
| K | NEA | PMDA | PMDA | BAPP |
| L | NIPA | PMDA | BPDA | ODA |
| M | NIPA | BPDA | BTDA | BAPP |
| N | NIPA | BPDA | BPDA | PPDA |
| O | NMA | PMDA | ODPA | ODA |
| P | NMA | OPDA | BPDA | BAPP |
| Q | NMA | BPDA | BTDA | ODA |
| R | NPA | BPDA | BPDA | BAPP |
| S | NPA | PMDA | ODPA | ODA |

Where BPDA = 3,3′,4,4′-Biphenyltetracarboxylic dianhydride
ODA = 4,4′-Oxydianiline
PMDA = Pyromellitic dianhydride
NMP = N-Methyl pyrrolidone
DMAc = Dimethylacetamide
NMA = N-Methylaniline
NEA = N-Ethylaniline
NBzA = N-Benzylaniline
NIPA = N-Isopropylaniline
NPA = N-Propylaniline
EC-BPDA = Endcapped-BPDA
BAPP = 2,2-Bis[4-(4-aminophenoxy)phenyl] propane
TPEQ = 1,4-Bis(4-aminophenoxy) benzene
ODPA = 4,4′-Oxydiphthalic anhydride
BTDA = 3,3′,4,4′-Benzophenonetetracarboxylic dianhydride

Further embodiments, any one of the above examples A to S may comprise one or more fillers. A few non-limiting examples of optional fillers include titanium (IV) oxide (TiO₂); silica or silicon dioxide (SiO₂); chromium (III) oxide (Cr₂O₃); alumina or aluminum oxide (Al₂O₃); zirconium oxide (ZrO₂); zinc oxide (ZnO); iron (III) oxide (Fe₂O₃); other suitable metal oxides; organometallic compounds; organometallic compounds formed from amine salts of metal oxide acids, such as molybdic acid, tungstic acid, or chromic acid; carbamate salt; thiocarbamate salt; thiophosphate salt; boron nitride.

Filler material may be added to the copolyimide at any suitable ratio. For example, in certain embodiments, a total amount of filler in a filled PI enamel insulation layer may be between approximately one percent (1.0%) and approximately thirty percent (30%) by weight. Different ratios may be utilized for different types of fillers. For example, metallic fillers or metal oxide fillers may be added at ratios between approximately ten percent (10%) and approximately twenty-five percent (30%) by weight, such as ratios between approximately fifteen percent (15%) and approximately twenty percent (20%) by weight. As another example, organometallic fillers may be added at relatively small ratios, such as ratios between approximately one percent (1.0%) and five percent (5.0%) by weight. In various other embodiments, a total amount of filler may be approximately 1, 2, 3, 5, 7.5, 10, 12.5, 15, 17.5, 20, 25, 30, 35, or 40 wt %, an amount included in a range between any two of the above values, or an amount included in a range bounded on either a minimum or maximum end by one of the above values.

In certain embodiments, improved flexibility resulting from the higher molecular weight of the polyimide (formed as a copolyimide according to preferred embodiments) allows higher filler ratios than those achieved by conventional polyimide. Further, adding filler may be utilized to improve one or more electrical performance characteristics of a coating or insulation formed from the polyimide, such as a thermal index and/or partial discharge inception voltage (“PDIV”). In certain embodiments, a coating formed from the polyimide described herein with filler incorporated into the coating may have a thermal index greater than 270° C., greater than 280° C. or in the range 265° C. to 285° C. as determined by International Standard ASTM D2307.

### Wire Coating

A magnetic wire, magnet wire or winding wire may include a conductor and any suitable number of insulation layers formed around the conductor. The present polyimide (or copolyimide) described herein may be utilized to form at least one insulation layer on a magnet wire and can be utilized to form any number of insulation layers around a conductor, such as a base coat, midcoat, intermediate coat, or topcoat.

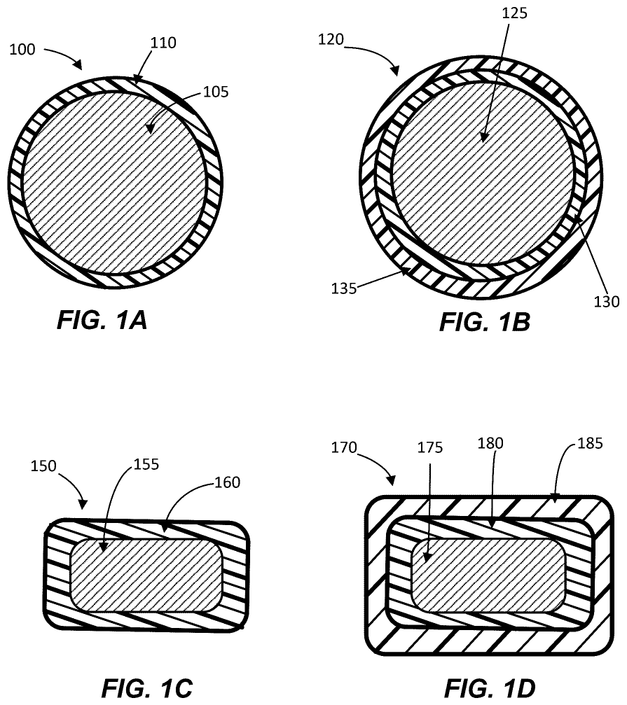

FIGS. 1A-1D illustrate cross-sectional views of example magnet wires constructions that each include at least one coating or insulation layer formed from the polyimide or copolyimide described herein. In particular, FIG. 1A illustrates a cross-sectional view of an example magnet wire having a round or circular cross-sectional shape in which a single layer of insulation 110 (which may include sublayers) is formed around a conductor 105. FIG. 1B illustrates another example magnet wire 120 having a round cross-sectional shape. The magnet wire 120 may include a conductor 125 and multiple layers 130, 135 of insulation formed around the conductor 125. In other words, the magnet wire 120 may include a basecoat insulation layer 130 formed around the conductor 125, and at least one additional layer of insulation (e.g., topcoat layer 135) formed around the basecoat 130. Although a single additional layer of insulation 135 is illustrated in FIG. 1B, any suitable number of insulation layers may be formed around a basecoat layer 130. For example, a magnet wire 120 may include a basecoat insulation layer, a midcoat insulation layer, and a topcoat insulation layer. In other embodiments, more than three insulation layers may be formed around a magnet wire.

FIG. 1C illustrates an example magnet wire 150 having a rectangular cross-sectional shape in which a single layer of insulation 160 (which may include sublayers) is formed around a conductor 155. FIG. 1D illustrates another example magnet wire 170 having a rectangular cross-sectional shape. Similar to the magnet wire 120 of FIG. 1B, the magnet wire 170 of FIG. 1D may include a conductor 175 and first and second layers 180, 185 of insulation formed around the conductor 175. In other words, the magnet wire 170 may include a basecoat insulation layer 180 formed around the conductor 175, and at least one additional layer of insulation (e.g., topcoat layer 185) formed around the basecoat 180. Any number of additional layers of insulation may be utilized as desired. For example, the magnet wire 170 may include two, three, or any other suitable number of total insulation layers.

The insulation layer(s) of the example magnet wire constructions 100, 120, 150, 170 illustrated in FIGS. 1A-1D may be formed from a wide variety of suitable materials and/or combinations of materials provided that at least one insulation layer or coating is formed from the polyimide (or copolyimide) described herein. For example, various insulation layers may be formed from thermosetting polymeric materials, thermoplastic polymeric materials and/or other suitable materials (e.g., semi-conductive materials, inorganic materials including ceramics, glass, etc.) Each insulation layer provides a covering that surrounds and completely entraps an outer periphery of the underlying conductor or insulation layer. Indeed, as described in greater detail below, magnet wire may be formed with a wide variety of suitable insulation systems.

Each of the layers or components of the magnet wire 170 of FIG. 1D will now be described in greater detail. The example magnet wires 100, 120, 150 of FIGS. 1A-IC may include layers or components similar to those described with reference to FIG. 1D. Indeed, as desired in various embodiments, a magnet wire may be formed with a wide variety of suitable cross-sectional shapes and insulation configurations.

With reference to FIG. 1D, the conductor 175 may be formed from a wide variety of suitable materials and/or combinations of materials. For example, the conductor 175 may be formed from copper, annealed copper, oxygen-free copper, silver-plated copper, nickel plated copper, tin plated copper, lead plated copper, molybdenum plated copper, tungsten plated copper, copper clad aluminum (“CCA”), a conductive alloy, a material that is coated with copper, or any other suitable electrically conductive material that includes copper. Additionally, the conductor 175 may be formed with any suitable dimensions and/or cross-sectional shapes. As shown, the conductor 175 may have a rectangular cross-sectional shape. In other embodiments, such as those illustrated in FIGS. 1A and 1C, a conductor may have a circular or round cross-sectional shape. In yet other embodiments, a conductor may be formed with a square shape, an elliptical or oval shape, a hexagonal shape, or any other suitable cross-sectional shape. Additionally, as desired for certain cross-sectional shapes such as the illustrated rectangular shape, a conductor may have corners that are rounded, sharp, smoothed, curved, angled, truncated, or otherwise formed. For example, a shaped rectangular wire may have rounded corners.

The conductor 175 may also be formed with any suitable dimensions, such as any suitable gauge, diameter, height, width, cross-sectional area, etc. As one non-limiting example, the longer sides of a rectangular conductor 175 may be between approximately 0.020 inches (508 μm) and approximately 0.750 inches (19050 μm), and the shorter sides may be between approximately 0.020 inches (508 μm) and approximately 0.400 inches (10160 μm). An example square conductor may have sides between approximately 0.020 inches (508 μm) and approximately 0.500 inches (12700 μm). An example round conductor may have a diameter between approximately 0.010 inches (254 μm) and approximately 0.500 inches (12700 μm). Other suitable dimensions may be utilized as desired.

With continued reference to FIG. 1D, a plurality of insulation layers 180, 185 are depicted as being formed around the conductor 175. In other embodiments, as shown in FIGS. 1A and 1C, a single insulation layer (e.g., a solcoat of enamel insulation, etc.) may be used. In the event that a plurality of insulation layers 180, 185 are formed around the conductor, any suitable number of insulation layers may be formed. In certain embodiments, each of a plurality of insulation layers may have identical or similar constructions (i.e., a plurality of enamel layers formed from the inventive polyimide). In other embodiments, at least two insulation layers may have different constructions. For example, at least two insulation layers may be formed from different materials, may be formed as filled or unfilled layers, and/or may include different fillers and/or differing amounts of fillers.

According to an aspect of the disclosure, at least one insulation layer is formed from the polyimide (or copolyimide) described herein. When applied as a thermosetting material, the polyimide may be applied as an enamel layer. An enamel layer is typically formed by applying a polymeric varnish to the conductor 175 (or an underlying layer) and then curing the applied varnish, for example, by baking the conductor in a suitable enameling oven or furnace. The polymeric varnish typically includes thermosetting polymeric material or resin suspended in one or more solvents. A thermosetting polymer is a material that may be irreversibly cured from a soft solid or viscous liquid (e.g., a powder, etc.) to an insoluble or cross-linked resin. Thermosetting polymers typically cannot be melted for application via extrusion as the melting process will break down or degrade the polymer. Thus, thermosetting polymers are suspended in solvents to form a varnish that can be applied and cured to form enamel film layers. Following application of a varnish, solvent is removed as a result of baking or other suitable curing, thereby leaving a solid polymeric enamel layer. As desired, a plurality of layers of enamel may be applied to the conductor 175 in order to achieve a desired enamel thickness or build (e.g., a thickness of the enamel obtained by subtracting the thickness of the conductor and any underlying layers). Each enamel layer may be formed utilizing a similar process. In other words, a first enamel layer may be formed, for example, by applying a suitable varnish and passing the conductor through an enameling oven. A second enamel layer may subsequently be formed by applying a suitable varnish and passing the conductor through either the same enameling oven or a different enameling oven. Indeed, an enameling oven may be configured to facilitate multiple passes of a wire through the oven. When the same material is applied in successive layers or sublayers, it may be referred to as a single layer or coat of insulation (e.g., a solcoat, a basecoat, etc.) on the magnet wire. As desired in various embodiments, other curing devices may be utilized in addition to or as an alternative to one or more enameling ovens. For example, one or more suitable infrared light, ultraviolet light, electron beam, and/or other curing systems may be utilized.

In certain embodiments, such as those illustrated in FIGS. 1A and 1C, a single polyimide/copolyimide insulation layer (e.g., a single enamel layer) may be formed around a magnet wire conductor. In other embodiments, one or more enamel layers of polyimide/copolyimide insulation may be combined with other insulation layers, such as enamel layers formed from other polymeric materials, thermoplastic insulation etc. Multi-layer insulation systems may be formed around magnet wire for a wide variety of different reasons. For example, a topcoat may be formed over an underlying filled enamel layer to provide abrasion resistance when the magnet wire is incorporated into a motor or other electric appliance. As another example, a multi-layer insulation system may be utilized to reduce overall costs. In particular, a basecoat or one or more underlying layers of an insulation system may be formed from lower cost, lower performance materials, and a higher performance material, such as the polyimide/copolyimide described herein, may be formed over the base layer(s). Use of a certain amount of higher performance material for a given application may result in a higher performance insulation system while the lower performance base layer(s) assist in controlling costs while achieving a desired insulation thickness. In certain embodiments, an insulation system may include at least three layers, such as a lower performance basecoat, a high performance midcoat (e.g., a filled midcoat incorporating the polyimide/copolyimide described herein), and a topcoat. As yet another example, a thermoplastic insulation layer may be formed over one or more enamel layers within an insulation system. Indeed, as stated above, a wide variety of different insulation systems may be utilized in conjunction with magnet wire. The materials utilized to form the various layers may be selected based upon the desired application for the magnet wire.

In the event that one or more enamel layers are combined with insulation formed from the polyimide/copolyimide described herein, a wide variety of suitable polymeric materials may be used to form another enamel layer. Examples of suitable thermosetting materials include, but are not limited to, polyimide (e.g., polyimide formed with a different formulation, etc.), polyamideimide, amideimide, polyester, polyesterimide, polysulfone, polyphenylenesulfone, polysulfide, polyphenylenesulfide, polyetherimide, polyamide, polyketones, etc. As desired, each layer of enamel included in an insulation system, such as a base coat, a midcoat and/or a topcoat, may be formed with any suitable number of sublayers. Each layer of enamel and/or a total enamel build may have any desired thickness, such as a thickness of approximately 0.0002, 0.0005, 0.007, 0.001, 0.002, 0.003, 0.004, 0.005, 0.006, 0.007, 0.008, 0.009, 0.010, 0.012, 0.015, 0.017, or 0.020 inches, a thickness included in a range between any two of the aforementioned values, and/or a thickness included in a range bounded on either a minimum or maximum end by one of the aforementioned values.

In the event that one or more thermoplastic layers are combined with insulation formed from the polyimide/copolyimide described herein, a wide variety of suitable polymeric materials may be used to form a thermoplastic layer. Examples of suitable polymeric materials include, but are not limited to, polyester, copolyester, polyamide including nylon and polyphenylamide (“PPA”), polyphenylene sulfide (“PPS”), polyphenylsulfone (“PPSU”), polyethersulfone (“PESU”), crosslinked polyolefins (e.g., crosslinked polyethylene, cyclopolyolefins (“COC”), etc.), polycarbonate, polystyrene, an acrylics polymer, a fluoropolymer, a silicone polymer, polyurethane, polyetheretherketone (“PEEK”), polyaryletherketone (“PAEK”), polyetherketoneketone (“PEKK”), etc. As desired, a thermoplastic layer may be formed from a single polymeric material or from a blend of two or more materials. In the event that a blend is utilized, any suitable blend ratios may be utilized.

The following is an itemized list of embodiments encompassed by the present concept, with such embodiments optionally being combined as indicated.

Embodiment 1—a polyimide may be provided having a formula 1:

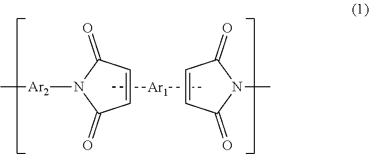

wherein Ar₁ is alkyl, phenyl or mixed alkyl-phenyl; or
wherein Ar₁ is a substituted or unsubstituted condensed aromatic ring or rings, a naphthalene, pyrene, and/or anthracene ring, or a substituted or unsubstituted heterocycle, a furan ring, a pyridine ring or an imidazole ring; and
wherein Ar₂ is a divalent phenyl ether, alky ether or alky-phenyl ether.

Embodiment 2—the polyimide according to Embodiment 1 wherein Ar₁ is any one or a combination of phenyl; biphenyl; benzophenone; biphenylether; or diphenylsulfone.

Embodiment 3—the polyimide according to Embodiment 1 or 2 wherein Ar₁ is any one or a combination of an alkane; a cycloalkane; or cyclohexane.

Embodiment 4—the polyimide according to any one of Embodiments 1 to 3 wherein Ar₂ is divalent diphenyl ether.

Embodiment 5—the polyimide according to Embodiment 1 wherein Ar₁ is biphenyl and Ar₂ is divalent diphenyl ether.

Embodiment 6—the polyimide according to any one of Embodiments 1 to 5 wherein comprising an intrinsic viscosity of >0.2, >0.22, >0.24, or >0.26, m³/kg as measured using measured International Standard ISO 1628-1:2021(en).

Embodiment 7—the polyimide according to any one of Embodiments 1 to 6 being a thermoset material.

Embodiment 8—a composite material comprising the polyimide according to any one of Embodiments 1 to 7 and a filler.

Embodiment 9—a wire comprising a coating comprising the polyimide according to any one of Embodiments 1 to 7 or a composite material according to Embodiment 8.

Embodiment 10—the wire according to Embodiment 9 wherein the coating comprises multiple layers of the polyimide bonded to one another as a unitary coating.

Embodiment 11—the wire according to Embodiments 9 or 10 wherein the coating comprises a thermal index greater than 260° C., or in the range 255 to 275° C., as determined by International Standard ASTM D2307.

Embodiment 12—the wire coating according to any one of Embodiments 9 to 11 wherein the coating comprises the composite material according to any one of Embodiments 18 or 19 and a thermal index greater than 270° C., greater than 280° C. or in the range 265° C. to 285° C. as determined by International Standard ASTM D2307.

Embodiment 13—an electrical device or electronic equipment comprising the wire according to any one of Embodiments 9 to 12.

Embodiment 14—the polyimide according to Embodiments 1 to 7 prepared by the steps of: (A) reacting a dianhydride monomer and an endcapping component to yield an endcapped acid terminated dianhydride intermediate; (B) reacting the endcapped acid terminated dianhydride intermediate, a diamine and a dianhydride monomer to yield a polyamic acid oligomer in which the endcapping component is a leaving group; and (C) heating the polyamic acid oligomer to yield the polyimide of formula 1.

Embodiment 15—the polyimide according to Embodiment 14 wherein the endcapping component is a primary amine or a secondary amine.

Embodiment 16—the polyimide according to Embodiment 15 wherein the secondary amine according to Embodiment 15 comprises one or a combination of N-alkylaniline; N-phenylaniline; N-alkyphenylaniline; or N-methylaniline (NMA).

Embodiment 17—the polyimide according to Embodiment 14 wherein the endcapping component comprises phthalic anhydride.

Embodiment 18—the polyimide according to any one of Embodiment 14 to 17 wherein the dianhydride monomer of the first reaction is a singular type of dianhydride monomer and/or the endcapped acid terminated dianhydride intermediate of the first reaction is a singular type of endcapped acid terminated dianhydride intermediate.

Embodiment 19—the polyimide according to any one of Embodiments 14 to 17 wherein the dianhydride monomer of the first reaction is the same dianhydride monomer as the second reaction; the dianhydride monomer of the first reaction is different to the dianhydride monomer as the second reaction; or the dianhydride monomer of the second reaction is combination of at least two different types of dianhydride monomer and optionally wherein the dianhydride monomer of the first reaction is the same or different to said at least two different types of dianhydride monomer of the second reaction.

Embodiment 20—the polyimide according to any one of Embodiments 14 to 17 wherein the dianhydride monomer of the first reaction and/or the second reaction comprises any one or a combination of: a cyclic anhydride; a carbocyclic carboxylic anhydrides; a phthalic anhydride or substituted phthalic anhydride; 3,3′,4,4′-biphenyltetracarboxylic dianhydride (BPDA); pyromellitic acid dianhydride (PMDA); 3,3′,4,4′-benzophenone tetracarboxylic acid dianhydride (BTDA); 3,3′,4,4′-biphenylether tetracarboxylic acid dianhydride (OPDA); diphenylsulfone tetracarboxylic acid dianhydride (DSDA); bicyclo(2,2,2)-octo-7-ene-2,3,5,6-tetracarboxylic acid dianhydride (BCD); 1,2,4,5-cyclohexane tetracarboxylic acid dianhydride (H-PMDA); 2,2-bis(3,4-dicarboxypheny) hexafluoro propane dianhydride (6FDA); 5-(2,5-dioxotetrahydrofuryl)-3-methyl-3-cyclohexene-1,2-dicarboxylic acid anhydride (CP), 4,4′-[propane-2,2-diylbis(1,4-phenylencoxy)]diphthalic acid dianhydride (BISDA); or 4,4′-oxydiphthalic acid anhydride (ODPA).

Embodiment 21—the polyimide according to any one of Embodiments 14 to 17 wherein the diamine comprises any one or a combination of: an aromatic diamine; an aliphatic diamine; oxydianiline (ODA); 3,4′-oxydianiline (3,4′-ODA); 4,4′-oxydianiline (4,4′-ODA); 1,4-bis(4-aminophenoxy)benzene (TPE-Q); 2,2-bis [4-(4-aminophenoxy)phenyl]propane (BAPP); p-phenylene diamine (PPDA).

Embodiment 22—the polyimide according to Embodiment 14 wherein the dianhydride monomer of the first reaction and/or the second reaction comprises 3,3′,4,4′-biphenyltetracarboxylic dianhydride (BPDA); the diamine comprises oxydianiline (ODA); and the endcapping component is any one or a combination of: N-alkylaniline; N-phenylaniline; N-alkyphenylaniline; N-methylaniline (NMA).

Embodiment 23—the polyimide according to Embodiment 14 wherein the dianhydride monomer of the first reaction comprises 3,3′,4,4′-biphenyltetracarboxylic dianhydride (BPDA); the dianhydride monomer of the second reaction comprises 3,3′,4,4′-biphenyltetracarboxylic dianhydride (BPDA), the diamine comprises oxydianiline (ODA); and the endcapping component is any one or a combination of: N-alkylaniline; N-phenylaniline; N-alkyphenylaniline; N-methylaniline (NMA).

Embodiment 24—the polyimide according to Embodiment 14 wherein the dianhydride monomer of the first reaction comprises pyromellitic acid dianhydride (PMDA); the dianhydride monomer of the second reaction comprises 3,3′,4,4′-biphenyltetracarboxylic dianhydride (BPDA); the diamine comprises oxydianiline (ODA); and the endcapping component is any one or a combination of: N-alkylaniline; N-phenylaniline; N-alkyphenylaniline; N-methylaniline (NMA).

Unless defined otherwise all technical and scientific terms used herein have the same meaning as commonly understood to one of ordinary skill in the art to which the presently described subject matter pertains.

Unless otherwise indicated, any reference to “wt %” refers to the mass fraction of the component relative to the total mass of the cemented carbide.

Where a range of values is provided, for example, concentration ranges, percentage range or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

It should be understood that the terms “a” and “an” as used above and elsewhere herein refer to “one or more” of the enumerated components. It will be clear to one of ordinary skill in the art that the use of the singular includes the plural unless specifically stated otherwise. Therefore, the terms “a”, “an” and “at least one” are used interchangeably in this application.

Unless otherwise indicated, all numbers expressing quantities of ingredients, properties such as size, weight, reaction conditions and so forth used in the specification and claims are to be understood as being modified in all instances by the term “about”. Accordingly, unless indicated to the contrary, the numerical parameters set forth in the following specification and attached claims are approximations that may vary depending upon the desired properties sought to be obtained by the present subject matter. At the very least, and not as an attempt to limit the application of the doctrine of equivalents to the scope of the claims, each numerical parameter should at least be construed in light of the number of reported significant digits and by applying ordinary rounding techniques.

Throughout the application, descriptions of various embodiments use “comprising” language; however, it will be understood by one of skill in the art that, in some instances, an embodiment can alternatively be described using the language “consisting essentially of” or “consisting of”.

The present subject matter being thus described, it will be apparent that the same may be modified or varied in many ways. Such modifications and variations are not to be regarded as a departure from the spirit and scope of the present subject matter, and all such modifications and variations are intended to be included within the scope of the following claims.

That which is claimed:

1. A polyimide having a formula 1: 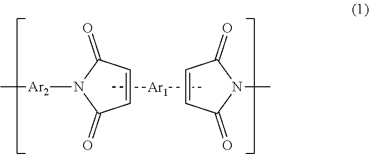
wherein Ar₁ is alkyl, phenyl or mixed alkyl-phenyl; or
wherein Ar₁ is a substituted or unsubstituted condensed aromatic ring or rings, a naphthalene, pyrene, and/or anthracene ring, or a substituted or unsubstituted heterocycle,
a furan ring, a pyridine ring or an imidazole ring; and
wherein Ar₂ is a divalent phenyl ether, alky ether or alky-phenyl ether.

2. The polyimide according to claim 1 wherein Ar₁ is any one or a combination of:
phenyl;
biphenyl;
benzophenone;
biphenylether;
diphenylsulfone.

3. The polyimide according to claim 1 wherein Ar₁ is any one or a combination of:
an alkane;
a cycloalkane;
cyclohexane.

4. The polyimide according to claim 1 wherein Ar₂ is divalent diphenyl ether.

5. The polyimide according to claim 1 wherein Ar₁ is biphenyl and Ar₂ is divalent diphenyl ether.

6. The polyimide according to claim 1 comprising an intrinsic viscosity of >0.2, >0.22, >0.24, or >0.26, m³/kg as measured using measured International Standard ISO 1628-1:2021(en).

7. The polyimide according to claim 1 being a thermoset material.

8. A composite material comprising:
the polyimide according to claim 1; and
a filler.

9. A wire comprising a coating comprising the polyimide of claim 1.

10. The wire according to claim 9 wherein the coating comprises multiple layers of the polyimide bonded to one another as a unitary coating.

11. The wire according to claim 9 wherein the coating comprises a thermal index greater than 260° C., or in the range 255 to 275° C., as determined by International Standard ASTM D2307.

12. A wire comprising a coating comprising the composite material of claim 8, wherein the coating comprises a thermal index greater than 270° C., greater than 280° C. or in the range 265° C. to 285° C. as determined by International Standard ASTM D2307.

13. An electrical device or electronic equipment comprising the wire according to claim 9.

14. The polyimide according to claim 1 prepared by the steps of:
(A) reacting a dianhydride monomer and an endcapping component to yield an endcapped acid terminated dianhydride intermediate;
(B) reacting the endcapped acid terminated dianhydride intermediate, a diamine and a dianhydride monomer to yield a polyamic acid oligomer in which the endcapping component is a leaving group; and
(C) heating the polyamic acid oligomer to yield the polyimide of formula 1.

15. The polyimide according to claim 14 wherein the endcapping component is a primary amine or a secondary amine.

16. The polyimide according to claim 15 wherein the secondary amine comprises any one or a combination of:
N-alkylaniline;
N-phenylaniline;
N-alkyphenylaniline;
N-methylaniline (NMA).

17. The polyimide according to claim 14 wherein the endcapping component is phthalic anhydride.

18. The polyimide according to claim 14 wherein the dianhydride monomer of the first reaction is a singular type of dianhydride monomer and/or the endcapped acid terminated dianhydride intermediate of the first reaction is a singular type of endcapped acid terminated dianhydride intermediate.

19. The polyimide according to claim 14 wherein:
the dianhydride monomer of the first reaction is the same dianhydride monomer as the second reaction;
the dianhydride monomer of the first reaction is different to the dianhydride monomer as the second reaction; or
the dianhydride monomer of the second reaction is combination of at least two different types of dianhydride monomer and optionally wherein the dianhydride monomer of the first reaction is the same or different to said at least two different types of dianhydride monomer of the second reaction.

20. The polyimide according to claim 14 wherein the dianhydride monomer of the first reaction and/or the second reaction comprises any one or a combination of:
a cyclic anhydride;
a carbocyclic carboxylic anhydrides;
a phthalic anhydride or substituted phthalic anhydride;
3,3′,4,4′-biphenyltetracarboxylic dianhydride (BPDA);
pyromellitic acid dianhydride (PMDA);
3,3′,4,4′-benzophenone tetracarboxylic acid dianhydride (BTDA);
3,3′,4,4′-biphenylether tetracarboxylic acid dianhydride (OPDA);
diphenylsulfone tetracarboxylic acid dianhydride (DSDA);
bicyclo(2,2,2)-octo-7-ene-2,3,5,6-tetracarboxylic acid dianhydride (BCD);
1,2,4,5-cyclohexane tetracarboxylic acid dianhydride (H-PMDA);
2,2-bis(3,4-dicarboxypheny) hexafluoro propane dianhydride (6FDA);
5-(2,5-dioxotetrahydrofuryl)-3-methyl-3-cyclohexene-1,2-dicarboxylic acid anhydride (CP), 4,4′-[propane-2,2-diylbis(1,4-phenyleneoxy)]diphthalic acid dianhydride (BISDA);
4,4′-oxydiphthalic acid anhydride (ODPA).

21. The polyimide according to claim 14 wherein the diamine comprises any one or a combination of:
an aromatic diamine;
an aliphatic diamine;
oxydianiline (ODA);
3,4′-oxydianiline (3,4′-ODA);
4,4′-oxydianiline (4,4′-ODA);
1,4-bis(4-aminophenoxy)benzene (TPE-Q);
2,2-bis[4-(4-aminophenoxy)phenyl]propane (BAPP);
p-phenylene diamine (PPDA).

22. The polyimide according to claim 14 wherein:
the dianhydride monomer of the first reaction and/or the second reaction comprises 3,3′,4,4′-biphenyltetracarboxylic dianhydride (BPDA);
the diamine comprises oxydianiline (ODA); and
the endcapping component is any one or a combination of: N-alkylaniline; N-phenylaniline; N-alkyphenylaniline; N-methylaniline (NMA).

23. The polyimide according to claim 14 wherein:
the dianhydride monomer of the first reaction comprises 3,3′,4,4′-biphenyltetracarboxylic dianhydride (BPDA);
the dianhydride monomer of the second reaction comprises 3,3′,4,4′-biphenyltetracarboxylic dianhydride (BPDA)
the diamine comprises oxydianiline (ODA); and
the endcapping component is any one or a combination of: N-alkylaniline; N-phenylaniline; N-alkyphenylaniline; N-methylaniline (NMA).

24. The polyimide according to claim 14 wherein:
the dianhydride monomer of the first reaction comprises pyromellitic acid dianhydride (PMDA);
the dianhydride monomer of the second reaction comprises 3,3′,4,4′-biphenyltetracarboxylic dianhydride (BPDA)
the diamine comprises oxydianiline (ODA); and
the endcapping component is any one or a combination of: N-alkylaniline; N-phenylaniline; N-alkyphenylaniline; N-methylaniline (NMA).
